(19) United States
(12) Patent Application Publication
(10) Pub. No.: US 2010/0093301 A1
(43) Pub. Date: Apr. 15, 2010

(54) HETERODYNE RECEIVER USING ANALOG DISCRETE-TIME SIGNAL PROCESSING AND SIGNAL RECEIVING METHOD THEREOF

(75) Inventors: Sung-Jun LEE, Daejon (KR); Seong-Min KIM, Daejon (KR); Taek-Jin HWANG, Daejon (KR); Kwang-Chun LEE, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/492,213

(22) Filed: Jun. 26, 2009

(30) Foreign Application Priority Data
Oct. 14, 2008 (KR) 10-2008-0100816
Dec. 10, 2008 (KR) 10-2008-0125158

(51) Int. Cl. H04B 1/26

(52) U.S. Cl. 455/313

(57) ABSTRACT

A heterodyne receiver of a wireless communication system using an analog discrete-time signal processing is provided. The heterodyne receiver includes: a radio signal processing unit configured to extract a signal of a desired band from a received radio signal and convert the extracted signal into an intermediate frequency (IF) signal that is an integer multiple of a sample rate specified in a specification of the wireless communication system; a discrete-time signal processing unit configured to charge-sample the IF signal in unit of a predetermined time and perform an anti-aliasing filtering and a successive decimation on the charge-sampled signal, a final output rate according to the decimation being an integer multiple of the specified sample rate; and an analog-to-digital conversion unit configured to convert the successively-decimated analog signal into a digital signal.

### CROSS-REFERENCES TO RELATED APPLICATIONS

The present invention claims priority of Korean Patent Application Nos. 10-2008-0100816 and 10-2008-0125158, filed on Oct. 14, 2008, and Dec. 10, 2008, respectively, which are incorporated herein by reference.

### BACKGROUND OF THE INVENTION

1. Field of the Invention

The present invention relates to an apparatus and a method for processing radio signals; and, more particularly, to an apparatus and a method for processing radio signals using a heterodyne scheme.

2. Description of Related Art

In the typical wireless communication systems, heterodyne or homodyne receivers using continuous-time signal processing have been used to receive radio signals. An architecture of a typical heterodyne receiver will be described with reference to the accompanying drawings.

FIG. 1A is a block diagram of a heterodyne receiver using a continuous-time signal processing.

A band-pass filter (BPF) 101 receives a radio signal through an antenna ANT and extracts a signal having a reception band from the received radio signal. A low noise amplifier (LNA) 102 amplifies the extracted signal, and a BPF 103 performs an image rejection on the amplified signal. The image-rejected signal is inputted to a mixer 104. The mixer 104 converts a radio frequency (RF) of the reception band inputted from the BPF 103 into an intermediate frequency (IF) by using a local oscillation signal f_{LO,RF} outputted from a local oscillator (not shown) configured to convert an RF into an IF. The IF signal from the mixer 104 is inputted to a BPF 105. The BPF 105 performs a channel selection process to pass only a signal of a channel selected at the IF band. The channel-selected signal is amplified by a gain determined at an automatic gain controller (AGC) 106.

The output signal of the AGC 106 is branched into two signals which are inputted to mixers 110 and 114. The mixers 110 and 114 convert the signals inputted from the AGC 106 into baseband signals by using a local oscillation signal f_{LO,IF} outputted from a local oscillator (not shown) configured to convert an IF into a baseband frequency. In this case, the local oscillation signal f_{LO, IF} outputted from the local oscillator (not shown) is directly inputted to the mixer 110, and the local oscillation signal f_{LO,IF} is also phase-shifted by π/2 by a phase shifter 113 and then inputted to the mixer 114. Signals other than the baseband signals are removed by low-pass filters (LPFs) 111 and 115. Then, analog-to-digital converters (ADCs) 112 and 116 corresponding to the LPFs 111 and 115 convert the analog signals into digital signals. A digital signal processor 121 extracts desired data from the digital signals.

The above-mentioned heterodyne receiver has been widely used for reasons of performance such as selectivity, but it is disadvantageous to integration due to increase of its size and structural complexity. Thus, the heterodyne receiver is less used in fields such as mobile communication terminals where the integration is important.

A homodyne receiver has not used for reasons of performance. However, with expansion of mobile communication markets, the integration probability and economic efficiency of the homodyne receiver have been reviewed. Consequently, as technologies capable of overcoming disadvantages in performance have been developed, the homodyne receiver is widely used as a chip integrated into a mobile communication terminal. A homodyne receiver will be described below with reference to FIG. 1B.

FIG. 1B is a block diagram of a homodyne receiver using a continuous-time signal processing.

A BPF 131 receives a radio signal through an antenna ANT and extracts a signal having the reception band. An LNA 132 amplifies the extracted signal by a predetermined amplification degree. The amplified signal from the LNA 132 is branched into two signals which are inputted to mixers 133 and 139. The mixers 133 and 139 convert the radio frequency signals of the reception band inputted from the LNA 132 into baseband frequency signals by using a local oscillation signal f_{LO,IF} outputted from a local oscillator (not shown) configured to convert an RF into a baseband frequency. Also, the local oscillation signal f_{LO,IF} outputted from the local oscillator (not shown) is directly inputted to the mixer 133, and the local oscillation signal f_{LO,IF} is also phase-shifted by π/2 by a phase shifter 138 and then inputted to the mixer 139. The baseband signals generated by the mixers 133 and 139 by using the phase-shifted local oscillation signal or the directly inputted local oscillation signal are inputted to LPFs 134 and 140 corresponding to the mixers 133 and 139. Since two paths in signal processing subsequent to the mixers 133 and 139 are equal to each other, only one of the two paths will be described below.

The output signal of the mixer 133 is inputted to the LPF 134 which performs a primary channel selection. This means a channel selection with respect to a band of one end. An AGC 135 compensates the channel-selected signal by a predetermined gain and outputs the gain-compensated signal to an LPF 136. The LPF 136 performs a secondary channel selection to select an actually desired signal. An ADC 137 converts the channel-selected signal into a digital signal, and a digital signal processor 151 extracts desired data from the digital signal.

There is a low-IF receiver architecture using a similar scheme to that of FIG. 1B. The low-IF receiver architecture may be considered as a kind of a homodyne architecture lessening a DC-offset problem. A detailed description of the low-IF receiver architecture will be omitted.

The receiver using the continuous-time signal processing has been described above, and a receiver using a discrete-time signal processing will be described below.

The receiver using the discrete-time signal processing has been taken into consideration relatively recently. The advent of such a receiver architecture may be associated with a Software Defined Radio (SDR) concept introduced in the 1990s. SDR is an attempt to perform an A/D conversion at a location as close to an antenna as possible and then apply a digital signal processing. Even though SDR uses a subsampling concept, ADC input bandwidth and power dissipation of the ADC and the digital signal processor may be blocking progress in implementation. As an approach to solving those problems, there has been proposed a discrete-time signal processor implemented with hardware such as Switched Capacitor Network (SCN) which has low power dissipation and is operable at high speed. In such a discrete-time signal processor, a discrete-time signal processing is performed on a sampled input signal having a high frequency, and as a consequence, a discrete-time signal having a low sample rate is outputted to the ADC.

The advent of the receiver using the discrete-time signal processing is associated with easy implementation of System on Chip (SoC). As mentioned above, the discrete-time signal processor is implemented with an SCN. Upon integration, the SCN uses the same “digital deep-submicron CMOS process” as the digital signal processor. Thus, it is advantageous to SoC implementation and, as processes are advanced, it is advantageous to application of new processes, without separate design modifications.

FIG. 2A is a block diagram of a receiver having a subsampling structure using a discrete-time signal processing.

Referring to FIG. 2A, a BPF 201 receives a signal through an antenna ANT. The BPF 201 extracts only a signal having a pre-selected frequency, that is, a band for communication, from the received signal. The output signal of the BPF 201 is low-noise-amplified by an LNA 202 and inputted to a BPF 203 for noise filtering. The BPF 203 eliminates noise from the output signal of the LNA 202 and outputs the noise-eliminated signal to a discrete-time signal processor 210. The discrete-time signal processor 210 includes a clock generator 212 and a voltage sampler 211. The clock generator 212 generates an arbitrary clock signal for sampling at a significantly lower frequency than an upper frequency of the communication band. The voltage sampler 211 samples the inputted signal using the generated clock signal. An ADC 220 converts the output signal of the discrete-time signal processor 210 into a digital signal. A digital signal processor 230 extracts desired data from the digital signal.

The receiver having the subsampling structure of FIG. 2A using the discrete-time signal processing samples the inputted signal at a significantly lower frequency than the upper frequency of the communication band and uses a spectrum falling within a first Nyquist zone in a periodic spectrum replica. The architecture of FIG. 2A is disclosed in many documents, for example, U.S. Pat. No. 7,110,732, filed on Sep. 19, 2006, entitled “Subsampling RF Receiver Architecture,” and “A 2.4-GHz RF Sampling Receiver Front-End in 0.18-um,” IEEE Journal of Solid-State Circuits, June 2005. Thus, detailed description of the architecture of FIG. 2A will be omitted herein.

Unlike the receivers of FIGS. 1A and 1B which performs the A/D conversion after the channel selection having a powerful filtering characteristic, the receiver architecture of FIG. 2A having the subsampling structure using the discrete-time signal processing may cause degradation of performance due to aliasing because the channel selection filter is applied after the sampling and the A/D conversion. The receiver architecture of FIG. 2A has not been applied as a chip integrated into a mobile communication terminal.

FIG. 2B is a block diagram of a receiver using a discrete-time signal processing based upon charge sampling.

Referring to FIG. 2B, a BPF 241 receives a signal through an antenna ANT. The BPF 241 extracts only a signal having a pre-selected frequency, that is, a band for communication, from the received signal. The output signal of the BPF 241 is low-noise-amplified by an LNA 242 and separated to two different lines. The signals separated by the LNA 242 are processed by trsnsconductance amplifiers (TAs) 243 and 244 and inputted to a discrete-time signal processor 250. The discrete-time signal processor 250 includes charge samplers 251 and 254, successive decimators 252 and 255, a clock generator 256, a local oscillation signal (f_{LO, RF}) generator (not shown), and a phase shifter 253. The local oscillation signal (f_{LO,RF}) generator (not shown) generates a local oscillation signal (f_{LO,RF}) for converting an RF into a baseband frequency. At this point, the decimation operations of the decimators 252 and 255 are accompanied by FIR/IIR filter operations. Although the signals inputted from the TAs 243 and 244 pass through the different paths, the TAs 243 and 244 perform the same operation. Thus, the following description will be made on only one path.

The charge sampler 251 is configured to have a “built-in anti-aliasing” characteristic by sampling charges that are generated by charging electric current into a capacitor during a time period when a sampling switch (not shown) is “on”. In the architecture of FIG. 2B, one RF charge sample is generated during the time period when the switch of the charge sampler is “on”. The sampled signal is inputted to the decimator 252 which performs a successive decimation operation accompanied with an anti-aliasing filtering to reduce an ADC rate and performs a partial channel filtering function. The signal filtered through those operations is converted into a digital signal by the ADC 261. Then, the digital signal processor 270 extracts a desired signal.

Even in the above-mentioned case of FIG. 2B, although the A/D conversion is performed before the main channel filtering, the receiver of FIG. 2B is free in the performance degradation problem caused by aliasing because of the “built-in anti-aliasing” characteristic of the charge sampling structure and the anti-aliasing filtering performed before the decimation.

The architecture of FIG. 2B is called a “direct RF sampling receiver” in the context that the RF charge sampling is performed directly on the RF input signal, or called a “discrete-time receiver” with emphasis on the operation of the discrete-time processor. Also, in some documents, the architecture of FIG. 2B is called a subsampling structure in the sense that the sample rate of the RF charge sample is lower than two times the upper frequency of the communication band.

The architecture of FIG. 2B is disclosed in many documents, for example, “Charge-Domain Signal Processing of Direct RF Sampling Mixer with Discrete-Time Filters in Bluetooth and GSM Receivers,” EURASIP J. Wireless Comm. Netw., 2006, and U.S. Pat. No. 7,079,826, filed on Jul. 18, 2006, entitled “Digitally Controlled Analog RF Filtering in Subsampling Communication Receiver Architecture”. Texas Instrument Incorporated commercialized the above-mentioned receiver as a chip integrated into a mobile communication terminal, and a large part of the documents related to the architecture of FIG. 2B was written by members of Texas Instrument Incorporated.

As can be seen from the architecture of FIG. 2B, since the ADC rate is determined in association with the radio frequency, the burden of Sample Rate Conversion (SRC) implantation may increase in the digital signal processor.

### SUMMARY OF THE INVENTION

An embodiment of the present invention is directed to an apparatus and method for removing the burden of SRC implementation in a digital signal processor by using a heterodyne receiver architecture using an analog discrete-time signal processing in an IF stage.

Another embodiment of the present invention is directed to a receiver, which is capable of supporting several communication specifications in a single hardware and is easy to integrate, and a method for controlling the same.

In accordance with an aspect of the present invention, there is provided a heterodyne receiver of a wireless communication system using an analog discrete-time signal processing, the heterodyne receiver including: a radio signal processing unit configured to extract a signal of a desired band from a received radio signal and convert the extracted signal into an intermediate frequency (IF) signal that is an integer multiple of a sample rate specified in a specification of the wireless communication system; a discrete-time signal processing unit configured to charge-sample the IF signal in unit of a predetermined time and perform an anti-aliasing filtering and a successive decimation on the charge-sampled signal, a final output rate according to the decimation being an integer multiple of the specified sample rate; and an analog-to-digital conversion unit configured to convert the successively-decimated analog signal into a digital signal.

In accordance with another aspect of the present invention, there is provided a method for processing a received signal in a wireless communication system using an analog discrete-time signal processing, the method including: extracting a signal of a desired band from a received radio signal and converting the extracted signal into an intermediate frequency (IF) signal that is an integer multiple of a sample rate specified in a specification of the wireless communication system; charge-sampling the IF signal in unit of a predetermined time and performing an anti-aliasing filtering and a successive decimation on the charge-sampled signal, a final output rate according to the decimation being an integer multiple of the specified sample rate; and converting the successively-decimated analog signal into a digital signal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIGS. 1A and 1B are block diagrams of a typical receiver architecture using a continuous-time signal processing.

FIGS. 2A and 2B are block diagrams of a typical receiver architecture using a discrete-time signal processing.

FIG. 3 is a block diagram of a heterodyne receiver using an analog discrete-time signal processing in an IF stage in accordance with an embodiment of the present invention.

FIG. 4 illustrates an IF selection of a receiver architecture supporting multiple communication standards in accordance with an embodiment of the present invention.

FIG. 5 is a graph of a minimum sample rate in FIG. 4.

FIG. 6 is a graph illustrating characteristics of the filter of FIG. 3 in several examples of FIG. 4.

### DESCRIPTION OF SPECIFIC EMBODIMENTS

The advantages, features and aspects of the invention will become apparent from the following description of the embodiments with reference to the accompanying drawings, which is set forth hereinafter.

The following description will be made on a heterodyne receiver architecture using an analog discrete-time signal processing in an IF stage, which is capable of removing the burden of SRC implementation in a digital signal processor and capable of supporting several communication specifications in a single hardware and also is easy to integrate.

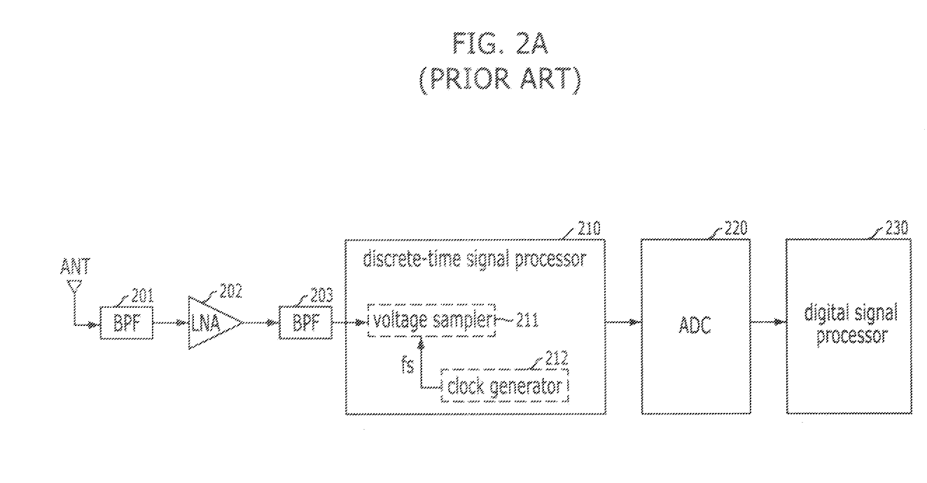

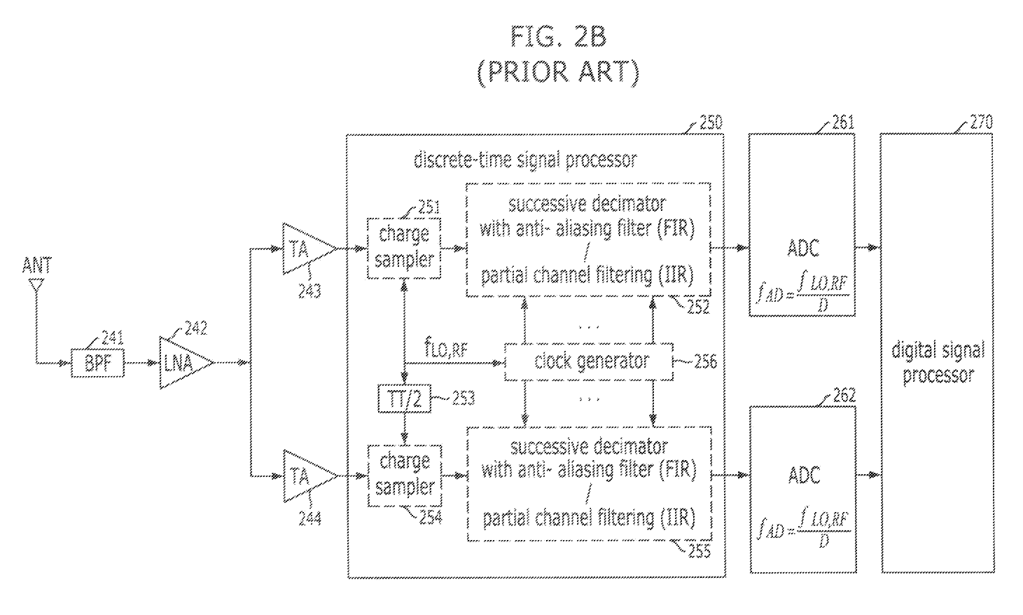

For complete understanding of the present invention, the architecture of FIG. 2B will be described in more detail. In the architecture of FIG. 2B, the ADC rate is determined by Equation 1 below.

$${f}_{AD} = \frac{{f}_{LO , RF}}{D} ( {f}_{LO , RF} ≅ {f}_{RF} ) \qquad Eq . 1$$

where D is a decimation factor of the discrete-time signal processor, and f_{LO,RF} is the operating rate of the charge sampler.

In the architecture of FIG. 2B, the operating rate of the charge sampler has a value around a center frequency of an RF signal inputted to the receiver.

However, there is no direct relation between the sample rate f_{s,standard} specified in the communication specification and the RF frequency used in the communication standard. Therefore, the digital signal processor needs to perform a complex Sample Rate Conversion (SRC) in order that the ADC rate f_{AD} determined from the RF frequency by using Equation 1 in the architecture of FIG. 2B is converted into the specified sample rate f_{s,standard}. If the RF frequency is accidentally the integer multiple of the sample rate f_{s,standard}, the SRC can be implemented using decimation accompanied by a simple filtering. However, as mentioned above, most of cases require a complex SRC because the RF frequency used is not determined from the sample rate specified in the communication specification.

In addition, when several frequency allocations (FAs) are used in the communication standard, a different SRC is required for each FA. Furthermore, when several communication specifications are supported, a complex SRC needs to be performed for each FA of the communication standards. Thus, the burden of the SRC implementation in the digital signal processor is increased. The increase in the burden of the digital signal processor coincides with the background of the advent of the architecture of FIG. 2 related to SDR. The motivation of the present invention is to still reduce the burden related to the SRC of the digital signal processor even though the above-mentioned scheme will be used in the receiver of the mobile communication terminal.

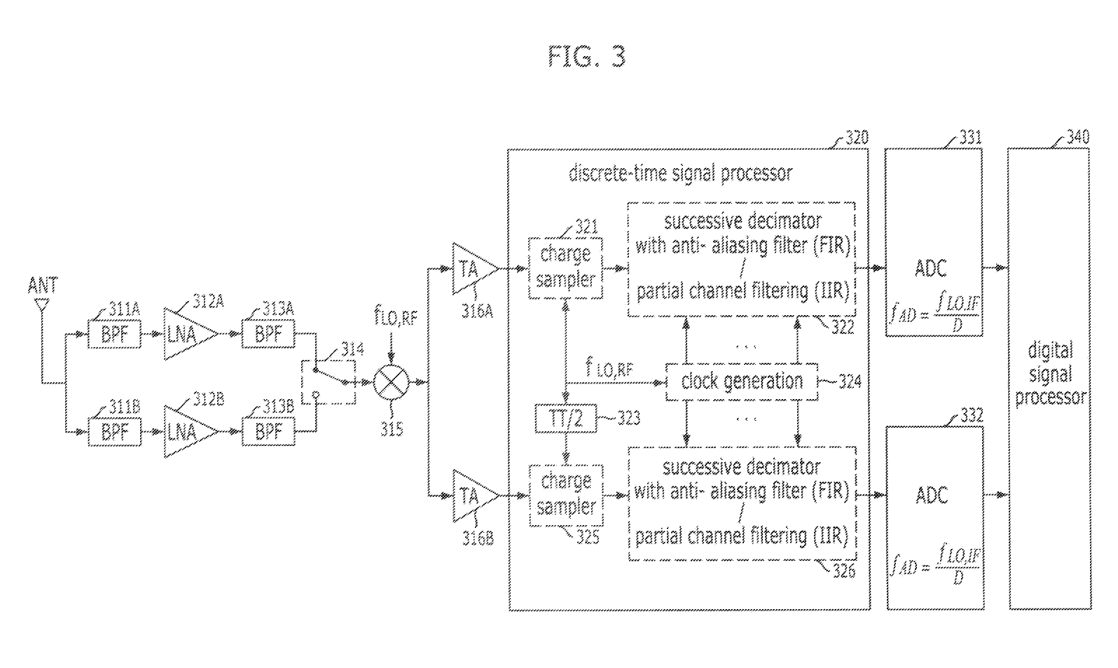

Accordingly, there is proposed a heterodyne receiver architecture using an analog discrete-time signal processing in an IF stage as illustrated in FIG. 3.

FIG. 3 is a block diagram of a heterodyne receiver using an analog discrete-time signal processing in an IF stage in accordance with an embodiment of the present invention.

Referring to FIG. 3, BPFs 311A and 311B receive a signal through an antenna ANT. The BPFs 311A and 311B extracts only a signal having a pre-selected frequency, that is, a band for communication, from the received signal. BPFs 313A and 313B corresponding to the respective lines removes image signals from the output signals of the LNAs 312A and 312B and inputted to a switch 314. The switch 314 is switched to input one of the first and second paths to a mixer 315, wherein the first path is a path passing through the BPF 311A, the LNA 312A and the BPF 313A, and the second path is a path passing through the BPF 311B, the LNA 312B and the BPF 313B.

The mixer 315 converts the RF signal into an IF signal by using a local oscillation signal f_{LO,RF} outputted from a local oscillator (not shown) configured to convert an RF into an IF. The IF signal is branched into two signals which are inputted to TAs 316A and 316B. The branched signals are processed by the TAs 316A and 316B and inputted to a discrete-time signal processor 320. The discrete-time signal processor 320 has the same structure as that of FIG. 2B. That is, the discrete-time signal processor 320 includes charge samplers 321 and 325, successive decimators 322 and 326, a clock generator 324, and a phase shifter 323. The phase shifter 323 shifts a phase of a local oscillation signal (f_{LO,IF}) from a local oscillator (not shown) configured to convert an IF into a baseband frequency. Although the signals inputted from the TAs 316A and 316B pass through the different paths, the TAs 316A and 316B perform the same operation. Thus, the following description will be made on only one path.

The charge sampler 321 is configured to have a “built-in anti-aliasing” characteristic by sampling charges that are generated by charging electric current into a capacitor during a time period when a sampling switch (not shown) is “on”. One IF charge sample is generated during the time period when the switch of the charge sampler is “on”. The sampled signal is inputted to the successive decimator 322 which performs a successive decimation operation accompanied with an anti-aliasing filtering to reduce an ADC rate and performs a partial channel filtering function. The signal filtered through those operations is converted into a digital signal by the ADC 331. Then, a digital signal processor 340 extracts a desired signal from the digital signal.

At this point, in the architecture in accordance with the embodiment of the present invention, the IF having an appropriate integer multiple of the sample rate specified in the communication standard is selected, and an ADC rate determined by Equation 2 with respect to a decimation factor D of the discrete-time signal processor is made to be an integer multiple of the specified sample rate. In this manner, the burden of SRC implementation in the digital signal processor 340 can be removed.

$${f}_{AD} = \frac{{f}_{LO , IF}}{D} ( {f}_{LO , IF} = {f}_{IF} , {f}_{IF} = \vert {f}_{RF} - {f}_{LO , RF} \vert ) \qquad Eq . 2$$

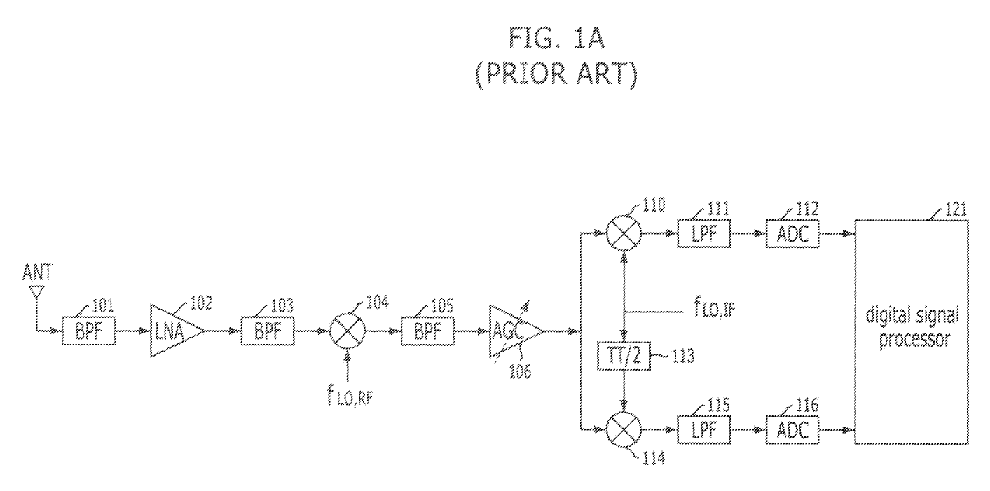

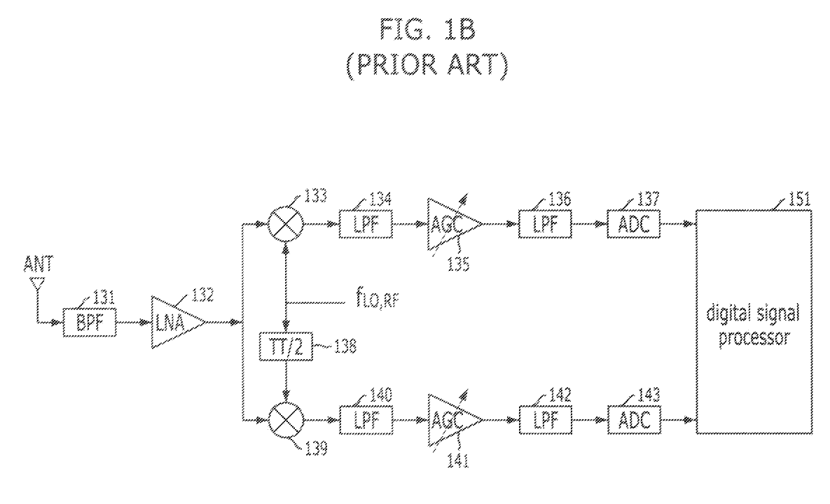

Furthermore, since the heterodyne structure is used, it is possible to obtain advantages over the homodyne structure in regard of performance, and the integration problem of the heterodyne structure like in FIG. 1B can be solved because the discrete-time signal processor 320 applied in the IF stage performs a function of an IF Surface Acoustic Wave (SAW) filter together with the digital signal processor 340.

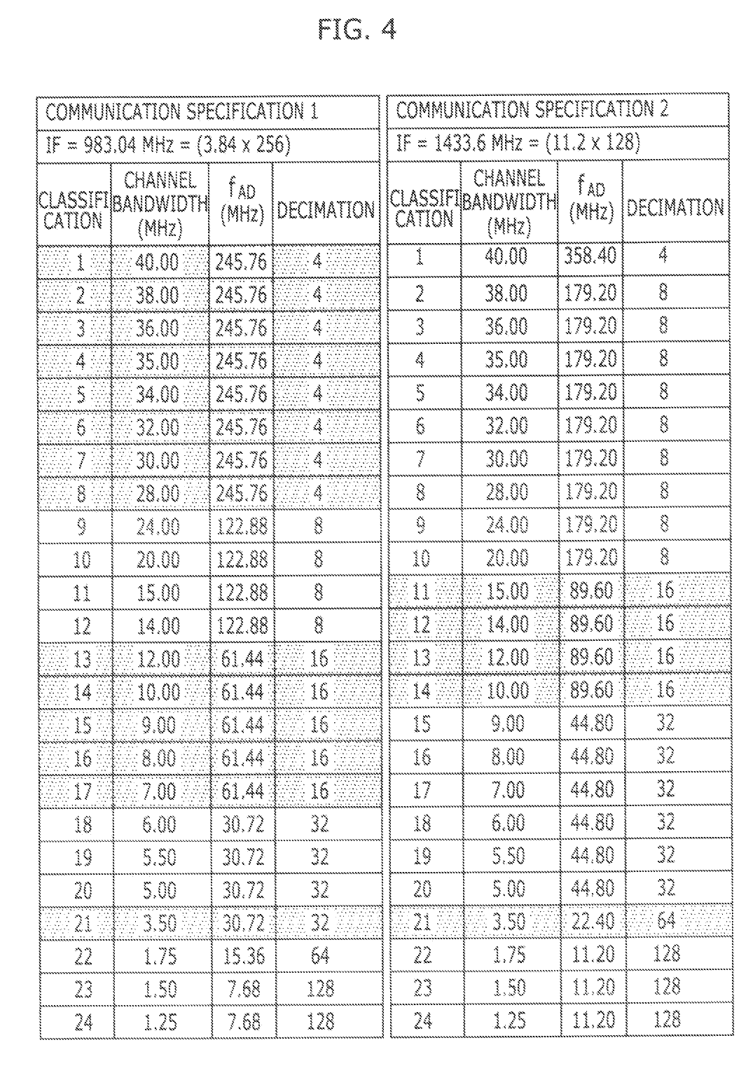

FIG. 4 illustrates channel bandwidths in accordance with two different communication specifications and values of D factors in accordance with the embodiment of the present invention.

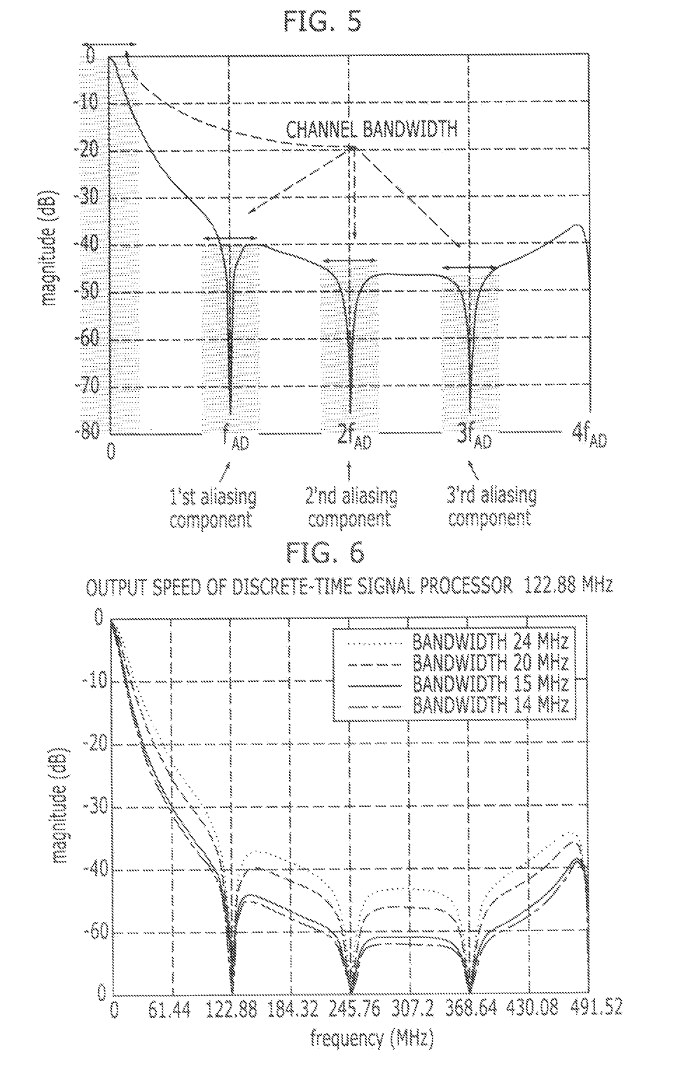

Specifically, FIG. 4 illustrates a case where the architecture of FIG. 3 is applied when the specified sample rates of the first and second communication specifications are an integer multiple of 3.84 MHz and an integer multiple of 11.2 MHz, respectively, and the two communication specifications need support bandwidths of 40 MHz, 38 MHz, . . . , 1.5 MHz, and 1.25 MHz. As illustrated in FIG. 5, the minimum sample rate means a sample rate that ensures the filtering of 30 dB or more on aliasing components, based upon up to the third aliasing component. The use of the higher sample rate than the minimum sample rate reinforces the anti-aliasing characteristic. Whether to use different sample rates or the highest sample rate with respect to the bandwidths is determined from the communication standard and the filtering characteristic of the stage prior to the discrete-time signal processor.

Among several cases of FIG. 4, the filter characteristic of only the discrete-time signal processor 320 when the bandwidth in the first communication standard is 24 MHz, 20 MHz, 15 MHz and 14 MHz is shown in FIG. 6. That is, FIG. 6 is a graph showing filter characteristics of the discrete-time signal processor.

The filter structure and design method of the discrete-time signal processor having the above-mentioned characteristics are used in the embodiments, but the present invention is not limited thereto. Thus, their detailed description will be omitted.

The heterodyne receiver using the analog discrete-time signal processing at the IF stage and the signal receiving method have the following effects.

First, the use of the heterodyne architecture can obtain the advantage of performance over the homodyne architecture, and the integration problem of the heterodyne architecture can be solved by designing the analog discrete-time signal processor and the digital signal processor to perform the function of the IF SAW filter.

Second, since the discrete-time signal processor applied to the IF stage uses the same “digital deep-submicron CMOS process” as the digital signal processor, it is advantageous to SoC implementation and, as processes are advanced, it is advantageous to application of new processes, without separate design modifications.

Third, in the heterodyne architecture using the analog discrete-time signal processing at the IF stage, the burden of SRC implementation in the digital signal processor can be removed by making the ADC rate after the discrete-time signal processing be the integer multiple of the sample rate specified in the communication specification.

While the present invention has been described with respect to the specific embodiments, it will be apparent to those skilled in the art that various changes and modifications may be made without departing from the spirit and scope of the invention as defined in the following claims.

What is claimed is:

1. A receiver of a wireless communication system, comprising:
a radio signal processing unit configured to extract a signal of a desired band from a received radio signal and convert the extracted signal into an intermediate frequency (IF) signal that is an integer multiple of a sample rate specified in a specification of the wireless communication system;
a discrete-time signal processing unit configured to charge-sample the IF signal in unit of a predetermined time and perform an anti-aliasing filtering and a successive decimation on the charge-sampled signal, a final output rate according to the decimation being an integer multiple of the specified sample rate; and
an analog-to-digital conversion unit configured to convert the successively-decimated analog signal into a digital signal.

2. The receiver of claim 1, wherein the discrete-time signal processing unit comprises:
a charge sampler configured to perform a sampling by charging electric charges of the IF signal in unit of the predetermined unit; and
a filter configured to perform the anti-aliasing filtering and the successive decimation on the sampled signal.

3. The receiver of claim 2, wherein the discrete-time signal processor comprises:
a clock generator configured to generate a predetermined clock;
a local oscillator configured to generate a frequency for converting the IF signal into a baseband signal; and
a phase shifter configured to shift a phase of an output of the local oscillator by π/2.

4. The receiver of claim 2, wherein the charge sampler and the filter are configured corresponding to an in-phase channel and a quadrature-phase channel in order for processing the channels.

5. The receiver of claim 1, further comprising a digital signal processor configured to process the digital signal to extract desired data.

6. The receiver of claim 1, wherein the receiver includes a heterodyne receiver of a wireless communication system using an analog discrete-time signal processing.

7. A method for processing a received signal in a wireless communication system, the method comprising:
extracting a signal of a desired band from a received radio signal and converting the extracted signal into an intermediate frequency (IF) signal that is an integer multiple of a sample rate specified in a specification of the wireless communication system;
charge-sampling the IF signal in unit of a predetermined time and performing an anti-aliasing filtering and a successive decimation on the charge-sampled signal, a final output rate according to the decimation being an integer multiple of the specified sample rate; and
converting the successively-decimated analog signal into a digital signal.

8. The method of claim 7, wherein said charge-sampling comprises:
performing a sampling by charging electric charges of the IF signal in unit of the predetermined unit.

9. The method of claim 8, further comprising:
processing the digital signal to extract desired data.

10. The method of claim 7, wherein the method is processed in a heterodyne receiver of a wireless communication system using an analog discrete-time signal processing.
